(19) United States
(12) Patent Application Publication
(10) Pub. No.: US 2026/0106675 A1
(43) Pub. Date: Apr. 16, 2026

(54) CHANNEL QUALITY REPORTING IN COMMUNICATION SYSTEM

(71) Applicant: HUAWEI TECHNOLOGIES CO., LTD., Shenzhen (CN)

(72) Inventors: Salah Eddine Hajri, Lund (SE); Lingrui Zhu, Bremen (DE); Thorsten Schier, Kista (SE); Carsten Bockelmann, Bremen (DE)

(73) Assignee: HUAWEI TECHNOLOGIES CO., LTD., Shenzhen (CN)

(21) Appl. No.: 19/422,004

(22) Filed: Dec. 16, 2025

Related U.S. Application Data
(63) Continuation of application No. PCT/EP2023/066380, filed on Jun. 19, 2023.

(51) Int. Cl. H04B 17/318; H04B 7/06

(52) U.S. Cl. CPC H04B 17/318; H04B 7/0626; H04B 7/0639

(57) ABSTRACT

Embodiments of the present disclosure relate to the channel quality reporting in a communication system (500). A first communication device (100) determines a channel quality quantity time series based on measured reference signals from a second communication device (300). The first communication device (100) quantizes the channel quality quantity time series based on a quantization codebook selected by the first communication device (100). The first communication device (100) transmits the quantized channel quality quantity time series (520) and an indication (520′) of the selected quantization codebook to the second communication device (300). Based on the indication (520′) of the selected quantization codebook, the second communication device (300) may reconstruct the channel quality quantity time series from the quantized channel quality quantity time series (520). Furthermore, the present disclosure also relates to corresponding methods and a computer program.

### CROSS-REFERENCE TO RELATED APPLICATIONS

This application is a continuation of International Application No. PCT/EP2023/066380, filed on Jun. 19, 2023, the disclosure of which is hereby incorporated by reference in its entirety.

### TECHNICAL FIELD

Embodiments of the present disclosure relate to channel quality reporting between a first communication device and a second communication device. Furthermore, embodiments of the present disclosure also relate to corresponding methods and a computer program.

### BACKGROUND

Artificial intelligence (AI), and more precisely machine learning (ML), methods have proven their worth in a multitude of fields, covering different problems, including classification, regression, and interaction with dynamic environments. Given the ability of some ML models to understand patterns and dependencies in the data, which are not typically captured by conventional signal processing techniques, exploiting their potential in the air interface of wireless communication networks could deliver non-negligible performance gains.

In this context, 3GPP agreed a study item in Rel-18, Study on Artificial Intelligence (AI)/Machine learning (ML) for NR air interface, to study the potential enhancements, performance gain, general framework and standard impact that ML methods would entail on the air interface, in several important use cases, including beam management, channel state information (CSI) reporting and positioning performance enhancements.

For ML-based CSI enhancements, CSI compression and CSI prediction are discussed. To enable CSI compression with lower overhead and improved reconstruction accuracy autoencoders are considered. The autoencoder based AI/ML model is a two-sided model for AI/ML based CSI feedback enhancement which enables more compression, resulting in reduced payload for the same or higher precoder accuracy at the network side.

CSI enhancements for ultra-reliable and low latency communication (URLLC) has also been discussed. In Rel-17, the work item “Enhanced Industrial Internet of Things (IoT) and ultra-reliable and low latency communication (URLLC) support for NR” studied among other, the required physical layer feedback enhancements for meeting URLLC requirements covering user equipment (UE) feedback enhancements for hybrid automatic repeat request acknowledgement (HARQ-ACK) and CSI feedback enhancements to allow for more accurate modulation and coding scheme (MCS) selection.

### SUMMARY

An objective of embodiments of the present disclosure is to provide a solution which mitigates or solves the drawbacks and problems of conventional solutions.

Another objective of embodiments of the present disclosure is to provide a solution for channel quality reporting with reduce overhead.

The above and further objectives are solved by the subject matter of the independent claims. Further embodiments of the present disclosure can be found in the dependent claims.

According to a first aspect of the present disclosure, the above mentioned and other objectives are achieved with a first communication device for a communication system, the first communication device being configured to:
measure reference signals received from a second communication device;
determine a channel quality quantity time series based on the measured reference signals;
select a quantization codebook based on the channel quality quantity time series;
quantize the channel quality quantity time series based on the selected quantization codebook; and
transmit the quantized channel quality quantity time series and an indication of the selected quantization codebook to the second communication device.

An advantage of the first communication device according to the first aspect is that the first communication device can report multiple values for one or multiple channel quality quantities with reduced quantization error and reporting overhead. The first communication device may report measured or predicted channel quality quantity time series. Ultimately, this would result in enhancing the timeline for obtaining relevant channel quality quantities. This enables to improve link adaptation, considering different key performance indicators such as reliability, latency and throughput.

In an embodiment form of a first communication device according to the first aspect, the first communication device is configured to:
receive a measurement configuration from the second communication device, the measurement configuration indicating a channel quality quantity to be determined and/or one or more quantization codebooks for channel quality time series quantization.
   An advantage with this embodiment form is that the proposed method can be supported with limited update to CSI reporting configuration. The different channel quality time series quantization codebooks can be configured as format or in other information elements within CSI reporting configuration or other radio resource measurement configuration.

In an embodiment form of a first communication device according to the first aspect, the measurement configuration is a channel state information configuration in a radio resource control signal.

An advantage with this embodiment form is that the proposed method can be supported with limited impact to the standard.

In an embodiment form of a first communication device according to the first aspect, the channel quality quantity time series is a predicted channel quality quantity time series.

An advantage with this embodiment form is that the timeline to obtain channel quality quantities, critical for link adaptation, is reduced. Ultimately this can be leveraged in order to perform more accurate MCS selection and adaptation, taking into consideration the predicted quantities and other physical layer feedback such as HARQ-ACK.

In an embodiment form of a first communication device according to the first aspect, the channel quality quantity time series is one or more of: a channel quality indicator time series, a modulation and coding scheme time series, and a signal-to-noise and interference ratio time series.

An advantage with this embodiment form is that different quantities that capture both channel and interference conditions, which impact latency, reliability and throughput, can be supported.

In an embodiment form of a first communication device according to the first aspect, the selected quantization codebook comprises a reference channel quality quantity coefficient and a plurality of differentially quantized coefficients, each differentially quantized coefficient corresponding to a prediction time step or to a prediction time step and a subband within a reporting bandwidth.

An advantage with this embodiment form is that both wideband and frequency selective quantities can be supported, e.g., wideband and frequency selective channel quality indicator (CQI). Additionally, using differential quantization with respect to a reference coefficient, enables to reduce the overall overhead needed to report the channel quality quantity time series.

In an embodiment form of a first communication device according to the first aspect, the first communication device is configured to:
select the quantization codebook among a plurality of quantization codebooks.

An advantage with this embodiment form is that the first communication device can select the quantization codebook that enables the most accurate time series quantization. Depending on the properties of the predicted or measured channel quality quantity time series, the best quantization codebook to quantize it, in terms of accuracy, differ. By selecting the proper quantization codebook, the first communication device can reduce the quantization error and, consequently, provide accurate channel quality reporting.

In an embodiment form of a first communication device according to the first aspect, each quantization codebook among the plurality of quantization codebooks represents different channel quality quantities quantization levels and/or different prediction time steps sampling rates.

An advantage with this embodiment form is that different interference and channel conditions can be supported. The proposed quantization codebook designs enable to accommodate the accurate quantization of channel quality quantity time series with different properties, e.g., dynamic range, periodicity, etc.

In an embodiment form of a first communication device according to the first aspect, the first communication device is configured to:
select the quantization codebook among the plurality of quantization codebooks based on one or more of: a time domain property of the channel quality quantity time series, a dynamic range of the channel quality quantity time series, and/or an accuracy of the quantized channel quality quantity time series according to each quantization codebook among the plurality of quantization codebooks.

An advantage with this embodiment form is that the different properties of the channel quality quantity time series are considered during the selection of the proper quantization codebook e.g., dynamic range, periodicity, and time domain correlation. By each quantization codebook being designed for time series properties, the quantization codebook selection of the first communication device can lead to minimizing the quantization error.

In an embodiment form of a first communication device according to the first aspect, the indication of the quantization codebook is a quantization codebook index.

An advantage with this embodiment form is that the second communication device can decode the reported channel quality quantity time series without ambiguity as it can derive which quantization codebook was used by the first communication device.

In an embodiment form of a first communication device according to the first aspect, the quantization codebook index is in a bit format. The quantization codebook index may be in a bitmap or combinatorial indicator format.

An advantage with this embodiment form is that minimum overhead can be used for quantization codebook indication.

In an embodiment form of a first communication device according to the first aspect, the first communication device is configured to:
transmit the quantized channel quality quantity time series and the indication of the quantization codebook in a first control signal; or
transmit the quantized channel quality quantity time series and the indication of the quantization codebook in a first control signal and in a second control signal, respectively.

An advantage with this embodiment form is that different uplink reporting resources can be supported. Additionally, a one part or two parts uplink control information can be used during reporting. This enables flexibility in defining the reporting resources and consequently can lead to less reports being dropped.

In an embodiment form of a first communication device according to the first aspect, the first control signal and the second control signal are uplink control information or medium access control control elements.

An advantage with this embodiment form is that uplink control information over physical uplink shared channel (PUSCH) or physical uplink control channel (PUCCH) can be used. Additionally, uplink medium access control control elements can be used to reduce constrains on intra-UE multiplexing.

According to a second aspect of the present disclosure, the above mentioned and other objectives are achieved with a second communication device for a communication system, the second communication device being configured to:
transmit reference signals to a first communication device; and
receive a quantized channel quality quantity time series and an indication of a quantization codebook from the first communication device, the quantized channel quality quantity time series comprising a channel quality quantity time series representing a channel quality quantity of the reference signals being quantized based on the indicated quantization codebook.

An advantage of the second communication device according to the second aspect is that channel quality quantities can be obtained, within a reasonable timeline, with limited overhead. The obtained channel quality quantities can be measured or predicted channel quality quantity time series. Ultimately, this would result in enhancing the timeline for obtaining relevant channel quality quantities. This enables to improve link adaptation, considering different key performance indicators such as reliability, latency and throughput.

In an embodiment form of a second communication device according to the second aspect, the second communication device is configured to:
reconstruct the channel quality quantity time series based on the quantized channel quality quantity time series and the indicated quantization codebook.

An advantage with this embodiment form is that the appropriate quantization codebook can be used by the second communication device during report decoding, without ambiguity.

In an embodiment form of a second communication device according to the second aspect, the second communication device is configured to:
reconstruct the channel quality time series based on an interpolation and/or an extrapolation of the quantized channel quality time series.

An advantage with this embodiment form is that the second communication device can use the reported time series as input to an interpolation and/or an extrapolation algorithm enabling to approximate the channel quality quantity for each time step, during scheduling.

In an embodiment form of a second communication device according to the second aspect, the second communication device is configured to:
transmit a measurement configuration to the first communication device, the measurement configuration indicating a channel quality quantity to be determined and/or one or more quantization codebooks for channel quality time series quantization.

An advantage with this embodiment form is that the proposed method can be supported with limited update or modification to CSI reporting configuration. The different channel quality time series quantization codebooks can be configured as format or in other information elements within CSI reporting configuration or other radio resource measurement configuration.

In an embodiment form of a second communication device according to the second aspect, the measurement configuration is a channel state information configuration in a radio resource control signal.

An advantage with this embodiment form is that the proposed method can be supported with limited impact to the standard.

In an embodiment form of a second communication device according to the second aspect, the channel quality quantity time series is a predicted channel quality quantity time series.

An advantage with this embodiment form is that the timeline to obtain channel quality quantities, critical for link adaptation, is reduced. Ultimately this can be leveraged in order to perform more accurate MCS selection and adaptation, taking into consideration the predicted quantities and other physical layer feedback such as HARQ-ACK.

In an embodiment form of a second communication device according to the second aspect, the channel quality quantity time series is one or more of: a channel quality indicator time series, a modulation and coding scheme time series, and a signal-to-noise and interference ratio time series.

An advantage with this embodiment form is that different quantities that capture both channel and interference conditions, which impact latency, reliability and throughput, can be supported.

In an embodiment form of a second communication device according to the second aspect, the indicated quantization codebook comprises a reference channel quality quantity coefficient and a plurality of differentially quantized coefficients, each differentially quantized coefficient corresponding to a prediction time step or to a prediction time step and a subband within a reporting bandwidth.

An advantage with this embodiment form is that both wideband and frequency selective quantities can be supported, e.g., wideband and frequency selective CQI. Additionally, using differential quantization with respect to a reference coefficient, enables to reduce the overall overhead needed to report the channel quality quantity time series.

In an embodiment form of a second communication device according to the second aspect, the indication of the quantization codebook is a quantization codebook index.

An advantage with this embodiment form is that the second communication device can decode the reported channel quality quantity time series without ambiguity as it can derive which quantization codebook was used by the first communication device.

In an embodiment form of a second communication device according to the second aspect, the quantization codebook index is in a bit format. The quantization codebook index may be in a bitmap or combinatorial indicator format.

An advantage with this embodiment form is that minimum overhead can be used for quantization codebook indication.

In an embodiment form of a second communication device according to the second aspect, the second communication device is configured to:
receive the quantized channel quality quantity time series and the indication of the quantization codebook in a first control signal; or
receive the quantized channel quality quantity time series and the indication of the quantization codebook in a first control signal and in a second control signal, respectively.

An advantage with this embodiment form is that different uplink reporting resources can be supported. Additionally, a one part or two parts uplink control information can be used during reporting. This enables flexibility in defining the reporting resources and consequently can lead to less reports being dropped.

In an embodiment form of a second communication device according to the second aspect, the first control signal and the second control signal are uplink control information or medium access control control elements.

An advantage with this embodiment form is that uplink control information over PUSCH or PUCCH can be used. Additionally, uplink medium access control control elements can be used to reduce constrains on intra-UE multiplexing.

According to a third aspect of the present disclosure, the above mentioned and other objectives are achieved with a method for a first communication device, the method comprises:
measuring reference signals received from a second communication device;
determining a channel quality quantity time series based on the measured reference signals;
selecting a quantization codebook based on the channel quality quantity time series;
quantizing the channel quality quantity time series based on the selected quantization codebook; and
transmitting the quantized channel quality quantity time series and an indication of the selected quantization codebook to the second communication device.

The method according to the third aspect can be extended into embodiment forms corresponding to the embodiment forms of the first communication device according to the first aspect. Hence, an embodiment form of the method comprises the feature(s) of the corresponding embodiment form of the first communication device.

The advantages of the methods according to the third aspect are the same as those for the corresponding embodiment forms of the first communication device according to the first aspect.

According to a fourth aspect of the present disclosure, the above mentioned and other objectives are achieved with a method for a second communication device, the method comprises:
transmitting refence signals to a first communication device; and
receiving a quantized channel quality quantity time series and an indication of a quantization codebook from the first communication device, the quantized channel quality quantity time series comprising a channel quality quantity time series representing a channel quality quantity of the reference signals being quantized based on the indicated quantization codebook.

The method according to the fourth aspect can be extended into embodiment forms corresponding to the embodiment forms of the second communication device according to the second aspect. Hence, an embodiment form of the method comprises the feature(s) of the corresponding embodiment form of the second communication device.

The advantages of the methods according to the fourth aspect are the same as those for the corresponding embodiment forms of the second communication device according to the second aspect.

Embodiments of the present disclosure also relate to a computer program, characterized in program code, which when run by at least one processor causes the at least one processor to execute any method according to embodiments of the present disclosure. Further, embodiments of the present disclosure also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

Further applications and advantages of embodiments of the present disclosure will be apparent from the following detailed description.

### BRIEF DESCRIPTION OF THE DRAWINGS

The appended drawings are intended to clarify and explain different embodiments of the present disclosure, in which:

FIG. 1 shows a first communication device according to an embodiment of the present disclosure;

FIG. 2 shows a flow chart of a method for a first communication device according to an embodiment of the present disclosure;

FIG. 3 shows a second communication device according to an embodiment of the present disclosure;

FIG. 4 shows a flow chart of a method for a second communication device according to an embodiment of the present disclosure;

FIG. 5 shows a communication system according to an embodiment of the present disclosure;

FIG. 6 shows signaling for channel quality reporting according to an embodiment of the present disclosure; and

FIG. 7 shows signaling for channel quality reporting in a 3GPP context according to an embodiment of the present disclosure.

### DETAILED DESCRIPTION

CSI prediction has been proposed as a scheme to enhance link adaptation in the framework of traffic with stringent reliability and delay requirements. Predicting CSI such as e.g., channel quality indicator (CQI) and modulation coding scheme (MCS) enables to address the issue of the CSI timeline, at least in part. However, self-contained CSI reports without explicit time-domain prediction has been the norm so far and no feedback format or method for reporting of predicted CSI has yet been agreed.

Industrial internet of things (IIoT) traffic is one type of traffic having stringent latency and reliability requirements. In IIoT scenarios, mobility patterns can be predictable, especially in factory floor scenarios. For example, robots and machinery used in manufacturing typically have predefined mobility tracks, e.g., to convey products/materials from one place in the manufacturing chain to the other. CSI enhancements for IIoT scenarios has been discussed in the 3GPP Rel-17 work item “Enhanced Industrial Internet of Things (IoT) and URLLC”, and solutions for outer loop link adaption (OLLA) and MCS selection enhancements were proposed therein. Additionally, CSI timeline enhancements was highlighted as an important aspect for low latency traffic patterns.

One way to enable enhanced MCS selection, while reducing the delay for obtaining CQI at the network side, is to enable CQI/MCS prediction at the UE and reporting of predicted CQI/MCS coefficients.

According to embodiments of the present disclosure a solution for channel quality reporting is therefore provided which may be used for measuring and reporting of predicted channel quality quantities while maintaining reasonable reporting overhead and accuracy.

FIG. 1 shows a first communication device 100 according to an embodiment of the present disclosure where the first communication device 100 is a client device. In the embodiment shown in FIG. 1, the first communication device 100 comprises a processor 102, a transceiver 104 and a memory 106. The processor 102 is coupled to the transceiver 104 and the memory 106 by communication means 108 known in the art. The first communication device 100 further comprises an antenna or antenna array 110 coupled to the transceiver 104, which means that the first communication device 100 is configured for wireless communications in a communication system.

The processor 102 may be referred to as one or more general-purpose central processing units (CPUs), one or more digital signal processors (DSPs), one or more application-specific integrated circuits (ASICs), one or more field programmable gate arrays (FPGAs), one or more programmable logic devices, one or more discrete gates, one or more transistor logic devices, one or more discrete hardware components, or one or more chipsets. The memory 106 may be a read-only memory, a random access memory (RAM), or a non-volatile RAM (NVRAM). The transceiver 104 may be a transceiver circuit, a power controller, or an interface providing capability to communicate with other communication modules or communication devices, such as network nodes and network servers. The transceiver 104, memory 106 and/or processor 102 may be implemented in separate chipsets or may be implemented in a common chipset.

That the first communication device 100 is configured to perform certain actions can in this disclosure be understood to mean that the first communication device 100 comprises suitable means, such as e.g., the processor 102 and the transceiver 104, configured to perform the actions.

According to embodiments of the present disclosure the first communication device 100 is configured to measure reference signals 510 received from a second communication device 300 and determine a channel quality quantity time series based on the measured reference signals. The first communication device 100 is further configured to select a quantization codebook based on the channel quality quantity time series and quantize the channel quality quantity time series based on the selected quantization codebook. Furthermore, the first communication device 100 is configured to transmit the quantized channel quality quantity time series 520 and an indication 520′ of the selected quantization codebook to the second communication device 300.

Furthermore, in an embodiment of the present disclosure, the first communication device 100 for a communication system 500 comprises: a transceiver configured to: measure reference signals 510 received from a second communication device 300; a processor configured to determine a channel quality quantity time series based on the measured reference signals, select a quantization codebook based on the channel quality quantity time series and quantize the channel quality quantity time series based on the selected quantization codebook; and a transceiver configured to and transmit the quantized channel quality quantity time series 520 and an indication 520′ of the selected quantization codebook to the second communication device 300.

Moreover, in yet another embodiment of the present disclosure, the first communication 100 for a communication system 500 comprises a processor and a memory having computer readable instructions stored thereon which, when executed by the processor, cause the processor to: measure reference signals 510 received from a second communication device 300; determine a channel quality quantity time series based on the measured reference signals; select a quantization codebook based on the channel quality quantity time series; quantize the channel quality quantity time series based on the selected quantization codebook; and transmit the quantized channel quality quantity time series 520 and an indication 520′ of the selected quantization codebook to the second communication device 300.

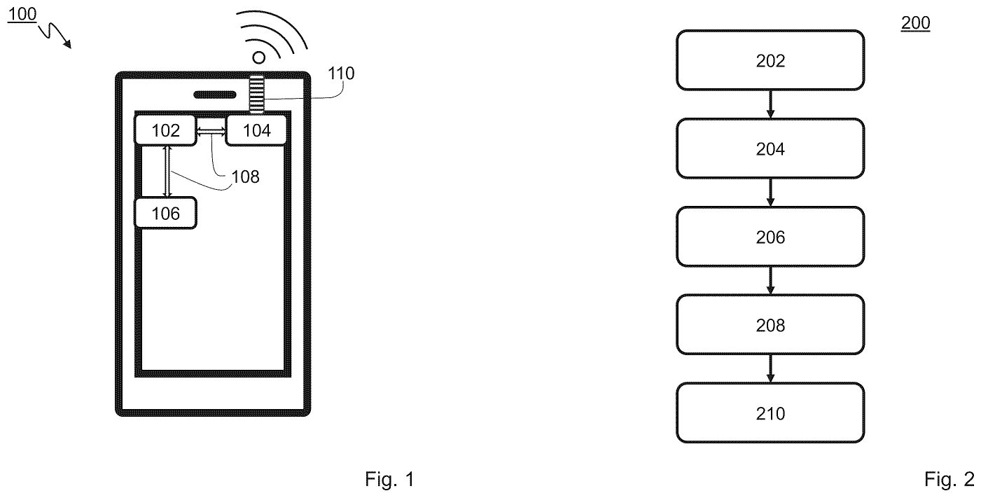

FIG. 2 shows a flow chart of a corresponding method 200 which may be executed in a first communication device 100, such as the one shown in FIG. 1. The method 200 comprises measuring 202 reference signals 510 received from a second communication device 300; determining 204 a channel quality quantity time series based on the measured reference signals; selecting 206 a quantization codebook based on the channel quality quantity time series; quantizing 208 the channel quality quantity time series based on the selected quantization codebook; and transmitting 210 the quantized channel quality quantity time series 520 and an indication 520′ of the selected quantization codebook to the second communication device 300.

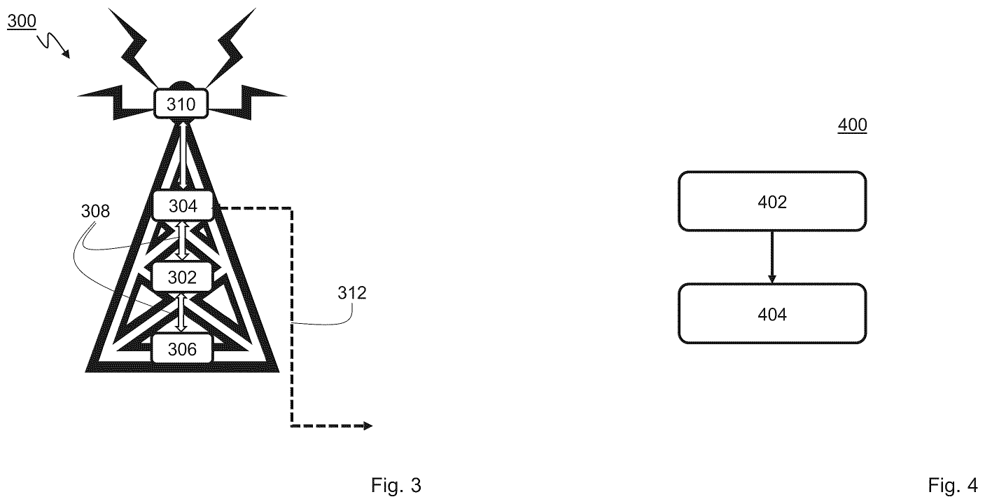

FIG. 3 shows a second communication device 300 according to an embodiment of the present disclosure where the second communication device 300 is a network access node. However, the second communication device 300 is not limited thereto and may in embodiments instead be a client device, such as e.g., the client device shown in FIG. 1. In the embodiment shown in FIG. 3, the second communication device 300 comprises a processor 302, a transceiver 304 and a memory 306. The processor 302 is coupled to the transceiver 304 and the memory 306 by communication means 308 known in the art. The second communication device 300 may be configured for wireless and/or wired communications in a communication system. The wireless communication capability may be provided with an antenna or antenna array 310 coupled to the transceiver 304, while the wired communication capability may be provided with a wired communication interface 312 e.g., coupled to the transceiver 304.

The processor 302 may be referred to as one or more general-purpose CPUs, one or more DSPs, one or more ASICs, one or more FPGAs, one or more programmable logic devices, one or more discrete gates, one or more transistor logic devices, one or more discrete hardware components, one or more chipsets. The memory 306 may be a read-only memory, a RAM, or a NVRAM. The transceiver 304 may be a transceiver circuit, a power controller, or an interface providing capability to communicate with other communication modules or communication devices. The transceiver 304, the memory 306 and/or the processor 302 may be implemented in separate chipsets or may be implemented in a common chipset.

That the second communication device 300 is configured to perform certain actions can in this disclosure be understood to mean that the second communication device 300 comprises suitable means, such as e.g., the processor 302 and the transceiver 304, configured to perform the actions.

According to embodiments of the present disclosure the second communication device 300 is configured to transmit refence signals 510 to a first communication device 100; and receive a quantized channel quality quantity time series 520 and an indication 520′ of a quantization codebook from the first communication device 100, the quantized channel quality quantity time series 520 comprising a channel quality quantity time series representing a channel quality quantity of the reference signals 510 being quantized based on the indicated quantization codebook.

Furthermore, in an embodiment of the present disclosure, the second communication device 300 for a communication system 500 comprises: a transceiver configured to: transmit refence signals 510 to a first communication device 100; and receive a quantized channel quality quantity time series 520 and an indication 520′ of a quantization codebook from the first communication device 100, the quantized channel quality quantity time series 520 comprising a channel quality quantity time series representing a channel quality quantity of the reference signals 510 being quantized based on the indicated quantization codebook.

Moreover, in yet another embodiment of the present disclosure, the second communication device 300 for a communication system 500 comprises a processor and a memory having computer readable instructions stored thereon which, when executed by the processor, cause the processor to: transmit refence signals 510 to a first communication device 100; and receive a quantized channel quality quantity time series 520 and an indication 520′ of a quantization codebook from the first communication device 100, the quantized channel quality quantity time series 520 comprising a channel quality quantity time series representing a channel quality quantity of the reference signals 510 being quantized based on the indicated quantization codebook.

FIG. 4 shows a flow chart of a corresponding method 400 which may be executed in a second communication device 300, such as the one shown in FIG. 3. The method 400 comprises transmitting 402 refence signals 510 to a first communication device 100; and receiving 404 a quantized channel quality quantity time series 520 and an indication 520′ of a quantization codebook from the first communication device 100, the quantized channel quality quantity time series 520 comprising a channel quality quantity time series representing a channel quality quantity of the reference signals 510 being quantized based on the indicated quantization codebook.

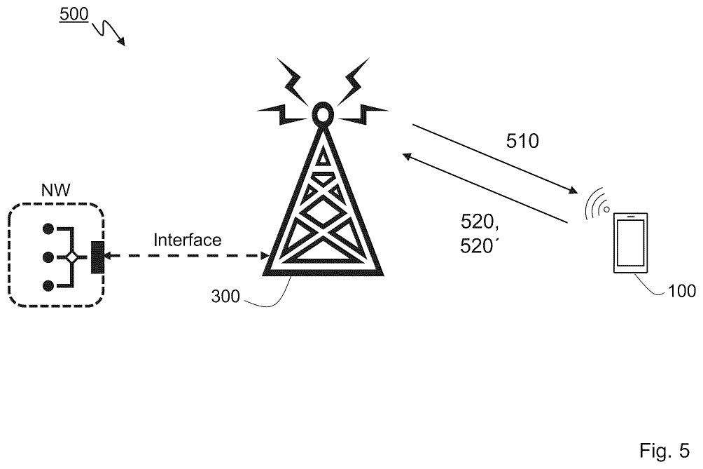

FIG. 5 shows a communication system 500 according to an embodiment of the present disclosure. The communication system 500 in the disclosed embodiment comprises a first communication device 100 and a second communication device 300 configured to communicate and operate in the communication system 500. In the shown embodiment, the first communication device 100 is configured as a client device and the second communication device 300 is configured as a network access node. However, in embodiments the second communication device 300 may be configured as a client device. The second communication device 300 being a network access node may be connected to a network NW such as e.g., a core network over a communication interface. The communication system 500 may be a communication system according to the 3GPP standard such as e.g., a 5G system in which case the client device may be a UE and the network access node may be a next generation node B (gNB) but the present disclosure is not limited thereto.

The first communication devices 100 and the second communication devices 300 communicate with each other over radio channels. The radio channels may be used for one or more of uplink, downlink, and sidelink communication depending on whether the first communication device 100 and the second communication device 300 are client devices and/or network access nodes. In case of a 5G system, the uplink/downlink communication may be performed over the Uu interface and the sidelink communication over the PC5 interface.

Embodiments of the present disclosure enables the first communication device 100 to determine a channel quality quantity time series and report the channel quality quantity time series to the second communication device 300 in an efficient manner based on quantization. With reference to FIG. 5, the first communication device 100 determines the channel quality quantity time series based on measurements of reference signals 510 received from the second communication device 300. The first communication device 100 quantizes the channel quality quantity time series based on a selected quantization codebook and transmit the quantized channel quality quantity time series 520 and an indication 520′ of the selected quantization codebook to the second communication device 300. The indication 520′ of the selected quantization codebook enables the second communication device 300 to reconstruct the channel quality quantity time series from the received quantized channel quality quantity time series 520.

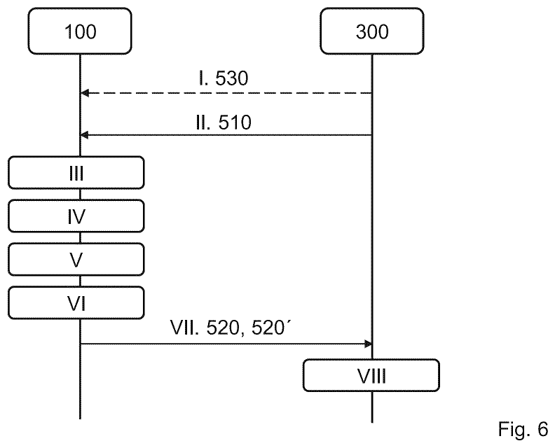

FIG. 6 shows signaling for channel quality reporting between a first communication device 100 and a second communication device 300 according to an embodiment of the present disclosure.

In operation I in FIG. 6, the second communication device 300 transmits a measurement configuration 530 to the first communication device 100. The measurement configuration 530 indicates a channel quality quantity to be determined and/or one or more quantization codebooks for channel quality time series quantization. The first communication device 100 receives the measurement configuration 530 from the second communication device 300 and hence obtains the channel quality quantity to be determined and/or one or more quantization codebooks for channel quality time series quantization indicated in the measurement configuration 530. The first communication device 100 may use this information In operation III to V in FIG. 6.

In embodiments, the measurement configuration 530 may be a CSI configuration in a radio resource control (RRC) signal. The measurement configuration 530 may be e.g., be a CSI configuration according to the 3GPP standard expanded to further indicate a channel quality quantity to be determined and/or one or more quantization codebooks for channel quality time series quantization.

In Operation I in FIG. 6, the information related to the channel quality quantity and/or quantization codebooks to use may in embodiments instead be e.g., pre-configured in the first communication device 100 or obtained from another communication device/node.

In operation II in FIG. 6, the second communication device 300 transmits reference signals 510 to the first communication device 100. The reference signals 510 may e.g., be channel state information reference signals (CSI-RS), synchronization signal block (SSB) or similar.

In operation III in FIG. 6, the first communication device 100 measures the reference signals 510 received from a second communication device 300. The first communication device 100 may measure the reference signals 510 based on the measurement configuration 530, e.g., measure to determine the channel quality quantity indicated in the measurement configuration 530.

In operation IV in FIG. 6, the first communication device 100 determines a channel quality quantity time series based on the measured reference signals. The channel quality quantity time series may be one or more of: a CQI time series, a MCS time series, and a signal-to-interference and noise ratio (SINR) series. In embodiments, the channel quality quantity time series is a predicted channel quality quantity time series. The channel quality quantity time series may e.g., be determined based on a channel quality prediction model such as a CQI prediction model where the measured reference signals are used as input. For channel quality quantity time series prediction, the first communication device 100 may use multiple measurements of the reference signals 510 as input to a prediction algorithm, such as a long short-term memory (LSTM)-based regression model, and obtain as output multiple future predicted CQI, MCS and/or SINR values.

In operation V in FIG. 6, the first communication device 100 selects a quantization codebook based on the channel quality quantity time series. The first communication device 100 may select a quantization codebook which is suitable to quantizes the channel quality quantity time series, e.g., gives the best representation of the predicted values of the channel quality quantity time series. The selected quantization codebook may comprise a reference channel quality quantity coefficient and a plurality of differentially quantized coefficients, each differentially quantized coefficient corresponding to a prediction time step or to a prediction time step and a subband within a reporting bandwidth. The time steps may be evenly spaced over the prediction horizon or indicated via a bitmap. Table 1 below shows examples of different combinations of coefficients for quantization codebooks.

In embodiments, the first communication device 100 selects the quantization codebook among a plurality of quantization codebooks. Each quantization codebook among the plurality of quantization codebooks may represent different channel quality quantities quantization levels and/or different prediction time steps sampling rates. The plurality of quantization codebooks may be received from the second communication device 300, e.g., indicated in the measurement configuration 530 and/or pre-configured in the first communication device 100.

The first communication device 100 may select the quantization codebook among the plurality of quantization codebooks based on one or more of: a time domain property of the channel quality quantity time series, a dynamic range of the channel quality quantity time series, and/or an accuracy of the quantized channel quality quantity time series according to each quantization codebook among the plurality of quantization codebooks. The time domain property may be based on an autocorrelation of the channel quality quantity time series and the dynamic range may be based on a difference between maximum and minimum values of the channel quality quantity time series. The accuracy of the quantized channel quality quantity time series may be based on an error value such as e.g., mean square error (MSE) or mean absolute error (MAE). Each quantization codebook, when used to quantize a given channel quality quantity time series, will result in an error value. The quantization codebook with the lowest error value would be the quantization codebook which most accurately represents the channel quality quantity time series and may be selected by the first communication device 100.

In operation VI in FIG. 6, the first communication device 100 quantizes the channel quality quantity time series based on the selected quantization codebook, i.e., the first communication device 100 determines a quantized channel quality quantity time series. The quantization may comprise deriving a reference channel quality quantity coefficient and a plurality of differentially quantized coefficients according to the quantization codebook. For example, the maximum, minimum, standard deviation or mean of predicted or measured channel quality quantity may be used as reference channel quality quantity coefficients. Differential quantization with respect to these reference channel quality quantity coefficients may then be used to obtain differentially quantized coefficients. In this way, a quantized channel quality quantity time series may be determined which can be reported with reduced overhead.

In operation VII in FIG. 6, the first communication device 100 transmits the quantized channel quality quantity time series 520 and an indication 520′ of the selected quantization codebook to the second communication device 300. The indication 520′ of the quantization codebook may be a quantization codebook index. The quantization codebook index may be in a bit format, e.g., in a bitmap or combinatorial indicator format. Table 1 shows an example of a bitmap format which may be used for the quantization codebook index.

TABLE 1

| Quantization | |
|---|---|
| codebook index | Quantization codebook content |
| 00 | One reference CQI coefficient (4 bits) + 16 |
| | differentially quantized coefficients (1 bits each) |
| 01 | One reference CQI coefficient (4 bits) + 8 |
| | differentially quantized coefficients (2 bits each) |
| 10 | One reference CQI coefficient (4 bits) + 4 |
| | differentially quantized coefficients (4 bits each) |

In the example shown in Table 1, all the quantization codebooks are based on a CQI coefficient as reference coefficient and 4 bits are used for the reference CQI coefficient. The quantization codebook index 00 indicates that the quantization codebook comprises 16 differentially quantized coefficients, each differentially quantized coefficient being indicated with 1 bit. The quantization codebook index 01 indicates that the quantization codebook comprises 8 differentially quantized coefficients, each differentially quantized coefficient being indicated with 2 bits. The quantization codebook index 11 indicates that the quantization codebook comprises 4 differentially quantized coefficients, each differentially quantized coefficient being indicated with 4 bits.

The first communication device 100 may transmit the quantized channel quality quantity time series 520 and the indication 520′ of the quantization codebook in the same or different control signals. Thus, the first communication device 100 may transmit the quantized channel quality quantity time series 520 and the indication 520′ of the quantization codebook in a first control signal, or the first communication device 100 may transmit the quantized channel quality quantity time series 520 in a first control signal and the indication 520′ of the quantization codebook in a second control signal. The first control signal and the second control signal may be uplink control information (UCI) or medium access control control elements (MAC-CEs).

In embodiments, the first communication device 100 may transmit the indication 520′ of the quantization codebook only when the selected quantization codebook changes. For example, the first communication device 100 may transmit a number of quantized channel quality quantity time series 520 without the indication 520′ of the quantization codebook as long as the same quantization codebook is used to quantize the channel quality quantity time series.

The second communication device 300 receives the quantized channel quality quantity time series 520 and the indication 520′ of a quantization codebook from the first communication device 100. The quantized channel quality quantity time series 520 comprises the channel quality quantity time series representing a channel quality quantity of the reference signals 510 being quantized based on the indicated quantization codebook.

The second communication device 300 may receive the quantized channel quality quantity time series 520 and the indication 520′ of the quantization codebook in a first control signal or in a first control signal and in a second control signal, respectively. The first control signal and the second control signal may be UCI or MAC-CEs.

As previously described, the indication 520′ of the quantization codebook may be a quantization codebook index, e.g., in a bit format, and the indicated quantization codebook may comprise a reference channel quality quantity coefficient and a plurality of differentially quantized coefficients, each differentially quantized coefficient corresponding to a prediction time step or to a prediction time step and a subband within a reporting bandwidth.

Furthermore, the channel quality quantity time series may be a predicted channel quality quantity time series, i.e., a channel quality quantity time series predicted by the first communication device 100. The channel quality quantity time series may further be one or more of: a CQI time series, a MCS time series, and a SINR time series.

Based on the quantized channel quality quantity time series 520 and the indicated quantization codebook, the second communication device 300 may reconstruct the channel quality quantity time series In operation VIII in FIG. 6. From the indication 520′ of the quantization codebook, the second communication device 300 obtains information about which quantization codebook the first communication device 100 has used for quantization. Using information from the indicated quantization codebook such as the reference channel quality quantity coefficient and/or the plurality of differentially quantized coefficients, the second communication device 300 may reconstruct the channel quality quantity time series from the received quantized channel quality quantity time series 520.

In embodiments, the second communication device 300 may further reconstruct the channel quality time series based on an interpolation and/or an extrapolation of the quantized channel quality time series 520. Different interpolation and extrapolation approaches may be used, e.g., spline or polynomial interpolation. The second communication device 300 may use the reported channel quality quantity time series as input to an interpolation and/or an extrapolation method which provides channel quality quantities for any of the considered time instances within the time spanned by the time series.

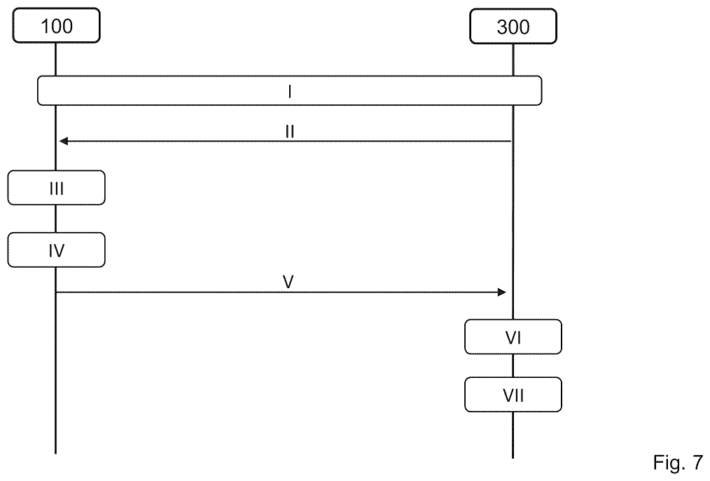

FIG. 7 shows further details related to embodiments of the present disclosure in a 3GPP context. The first communication device 100 is in this embodiment a UE and the second communication device 300 is a network access node such as e.g., a gNB configured for communication in a 3GPP system. It may however be noted that embodiments of the present disclosure are not limited thereto.

In operation I in FIG. 7, the first communication device 100 and the second communication device 300 performs capability transfer and RRC configuration in a conventional way. According to embodiments of the present disclosure the RRC configuration procedure may further comprise the second communication device 300 transmitting a measurement configuration 530 indicating a channel quality quantity to be determined and/or one or more quantization codebooks for channel quality time series quantization to the first communication device 100.

In operation II in FIG. 7, the second communication device 300 triggers CSI reporting for the first communication device 100. Based on the trigger, the first communication device 100 measures downlink reference signals received from the second communication device 300 and computes one or more CQI/MCS/SINR reports and prepares a channel quality quantity time series In operation III in FIG. 7.

In operation IV in FIG. 7, the first communication device 100 selects a quantization codebook based on the channel quality quantity time series and quantizes the channel quality quantity time series based on the selected quantization codebook. The selection and quantization may be performed according to any of the herein descried embodiments.

In operation V in FIG. 7, the first communication device 100 transmits the quantized channel quality quantity time series 520 and an indication 520′ of the selected quantization codebook to the second communication device 300, e.g., in an UCI over a physical uplink shared channel (PUSCH) and/or a physical uplink control channel (PUCCH). The indication 520′ of the selected quantization codebook may be transmitted with each quantized channel quality quantity time series 520 or only transmitted when the quantization codebook selected and used for quantization by the first communication device 100 changes, e.g., due to a change in channel conditions.

In operation VI in FIG. 7, the second communication device 300 receives the quantized channel quality quantity time series 520 and the indication 520′ of the selected quantization codebook and may hence determine the quantization codebook used by the first communication device 100.

In operation VII in FIG. 7, the second communication device 300 decodes the rest of the UCI and derives the channel quality quantity time series based on the indicated quantization codebook.

A first communication device herein may also be denoted as a client device. A second communication device herein may also be denoted as a network access node or a client device.

A client device herein may be denoted as a user device, a user equipment (UE), a mobile station, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station, which is any device that contains an IEEE 802.11-conformant MAC and PHY interface to the WM. The UE may be configured for communication in 3GPP related LTE, LTE-advanced, 5G wireless systems, such as NR, and their evolutions, as well as in IEEE related Wi-Fi, WiMAX and their evolutions.

A network access node herein may also be denoted as a radio network access node, an access network access node, an access point (AP), or a base station (BS), e.g., a radio base station (RBS), which in some networks may be referred to as transmitter, “gNB”, “gNodeB”, “eNB”, “eNodeB”, “NodeB” or “B node”, depending on the standard, technology and terminology used. The radio network access node may be of different classes or types such as e.g., macro eNodeB, home eNodeB or pico base station, based on transmission power and thereby the cell size. The radio network access node may further be a station, which is any device that contains an IEEE 802.11-conformant media access control (MAC) and physical layer (PHY) interface to the wireless medium (WM). The radio network access node may be configured for communication in 3GPP related long term evolution (LTE), LTE-advanced, fifth generation (5G) wireless systems, such as new radio (NR) and their evolutions, as well as in IEEE related Wi-Fi, worldwide interoperability for microwave access (WiMAX) and their evolutions.

Furthermore, any method according to embodiments of the present disclosure may be implemented in a computer program, having code means, which when run by processing means causes the processing means to execute the steps of the method. The computer program is included in a computer readable medium of a computer program product. The computer readable medium may comprise essentially any memory, such as previously mentioned a ROM, a PROM, an EPROM, a flash memory, an EEPROM, or a hard disk drive.

Moreover, it should be realized that the first communication device and the second communication device comprise the communication capabilities in the form of e.g., functions, means, units, elements, etc., for performing or implementing embodiments of the present disclosure. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, TCM encoder, TCM decoder, power supply units, power feeders, communication interfaces, communication protocols, etc. which are suitably arranged together for performing the solution.

Therefore, the processor(s) of the first communication device and the second communication device may comprise, e.g., one or more instances of a CPU, a processing unit, a processing circuit, a processor, an ASIC, a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the present disclosure is not limited to the embodiments described above, but also relates to and incorporates all embodiments within the scope of the appended independent claims.

1. A first communication device, comprising:
at least one processor, and
one or more memories coupled to the at least one processor and storing programming instructions that, when executed by the at least one processor, cause the at least one processor to:
measure reference signals received from a second communication device;
determine a channel quality quantity time series based on the measured reference signals;
select a quantization codebook based on the channel quality quantity time series;
quantize the channel quality quantity time series based on the selected quantization codebook; and
transmit the quantized channel quality quantity time series and an indication of the selected quantization codebook to the second communication device.

2. The first communication device according to claim 1, wherein the eat least one processor is further to:
receive a measurement configuration from the second communication device indicating at least one of a channel quality quantity to be determined or one or more quantization codebooks for channel quality quantity time series quantization.

3. The first communication device according to claim 2, wherein the measurement configuration is a channel state information configuration in a radio resource control signal.

4. The first communication device according to claim 1, wherein the channel quality quantity time series is a predicted channel quality quantity time series.

5. The first communication device according to claim 1, wherein the channel quality quantity time series is one or more of:
a channel quality indicator time series;
a modulation and coding scheme time series; or
a signal-to-noise and interference ratio time series.

6. The first communication device according to claim 1, wherein the selected quantization codebook comprises a reference channel quality quantity coefficient and a plurality of differentially quantized coefficients, each differentially quantized coefficient corresponding to a prediction time step or to a prediction time step and a subband within a reporting bandwidth.

7. The first communication device according to claim 1, wherein the at least one processor is further to:
select the quantization codebook among a plurality of quantization codebooks.

8. The first communication device according to claim 7, wherein each quantization codebook among the plurality of quantization codebooks represents at least one of different channel quality quantities quantization levels or different prediction time steps sampling rates.

9. The first communication device according to claim 7, wherein the at least one processor is further to:
select the quantization codebook among the plurality of quantization codebooks based on one or more of:
a time domain property of the channel quality quantity time series;
a dynamic range of the channel quality quantity time series; or
an accuracy of the quantized channel quality quantity time series according to each quantization codebook among the plurality of quantization codebooks.

10. A second communication device, comprising:
at least one processor; and
one or more memories coupled to the at least one processor and storing programming instructions that, when executed by the at least one processor, cause the at least one processor to:
transmit reference signals to a first communication device; and
receive a quantized channel quality quantity time series and an indication of a quantization codebook from the first communication device, the quantized channel quality quantity time series comprising a channel quality quantity time series representing a channel quality quantity of the reference signals being quantized based on the indicated quantization codebook.

11. The second communication device according to claim 10, wherein the at least one processor is further to:
reconstruct the channel quality quantity time series based on the quantized channel quality quantity time series and the indicated quantization codebook.

12. The second communication device according to claim 11, wherein the at least one processor is further to:
reconstruct the channel quality quantity time series based on at least one of an interpolation or an extrapolation of the quantized channel quality time series.

13. The second communication device according to claim 10, wherein the at least one processor is further to:
transmit a measurement configuration to the first communication device that indicates at least one of a channel quality quantity to be determined or one or more quantization codebooks for channel quality time series quantization.

14. The second communication device according to claim 13, wherein the measurement configuration is a channel state information configuration in a radio resource control signal.

15. The second communication device according to claim 10, wherein the channel quality quantity time series is a predicted channel quality quantity time series.

16. The second communication device according to claim 10, wherein the channel quality quantity time series is one or more of:
a channel quality indicator time series;
a modulation and coding scheme time series; or
a signal-to-noise and interference ratio time series.

17. The second communication device according to claim 10, wherein the indicated quantization codebook comprises a reference channel quality quantity coefficient and a plurality of differentially quantized coefficients, each differentially quantized coefficient corresponding to a prediction time step or to a prediction time step and a subband within a reporting bandwidth.

18. The second communication device according to claim 10, wherein the indication of the quantization codebook is a quantization codebook index.

19. A method for a first communication device, the method comprising:
measuring reference signals received from a second communication device;
determining a channel quality quantity time series based on the measured reference signals;
selecting a quantization codebook based on the channel quality quantity time series;
quantizing the channel quality quantity time series based on the selected quantization codebook; and
transmitting the quantized channel quality quantity time series and an indication of the selected quantization codebook to the second communication device.

20. The method of claim 19, further comprising:
receiving a measurement configuration from the second communication device indicating at least one of a channel quality quantity to be determined or one or more quantization codebooks for channel quality quantity time series quantization.
